(19) United States
(12) Patent Application Publication
(10) Pub. No.: US 2010/0002773 A1
(43) Pub. Date: Jan. 7, 2010

(54) Motion-Compensated Temporal Recursive Filter

(76) Inventors: Anthony Richard Huggett, Eastleigh (GB); Anthony Richard Jones, Surrey (GB)

Correspondence Address: COATS & BENNETT, PLLC, 1400 Crescent Green, Suite 300, Cary, NC, 27518, US

(21) Appl. No.: 12/513,957

(22) PCT Filed: Nov. 9, 2007
(86) PCT No.: PCT/GB2007/004294

§ 371 Date: Aug. 12, 2009

(30) Foreign Application Priority Data
Nov. 10, 2006 (GB) 0622490.1

(51) Int. Cl. H04N 7/26

(52) U.S. Cl. 375/240.16; 375/E07.123

(57) ABSTRACT

Motion compensation means for a time recursive filter includes a block motion estimation module (12) having an input video signal (1) and a input delayed output signal (6) of the time recursive filter. The block motion estimation module outputs block motion vectors (13) to at least one block splitting stage (14, 16, 18) which together with the input video signal (1) and the delayed output signal (6) of the time recursive filter is arranged to produce at least sub-block motion vectors (15, 17, 19) for input into image reconstruction means (9) to produce a motion-compensated image (11).

This invention relates to a motion-compensated temporal recursive filter.

Noise in digital video sequences poses a serious problem for video compression engines. Noise typically has high spatial (and temporal) frequency coefficients. In video compression this noise either consumes many bits to encode, or leads to unpleasant artefacts if the bit rate is too low to allow the noise to be encoded. Therefore it is desirable to remove noise from video streams prior to encoding.

### The Temporal Recursive Filter

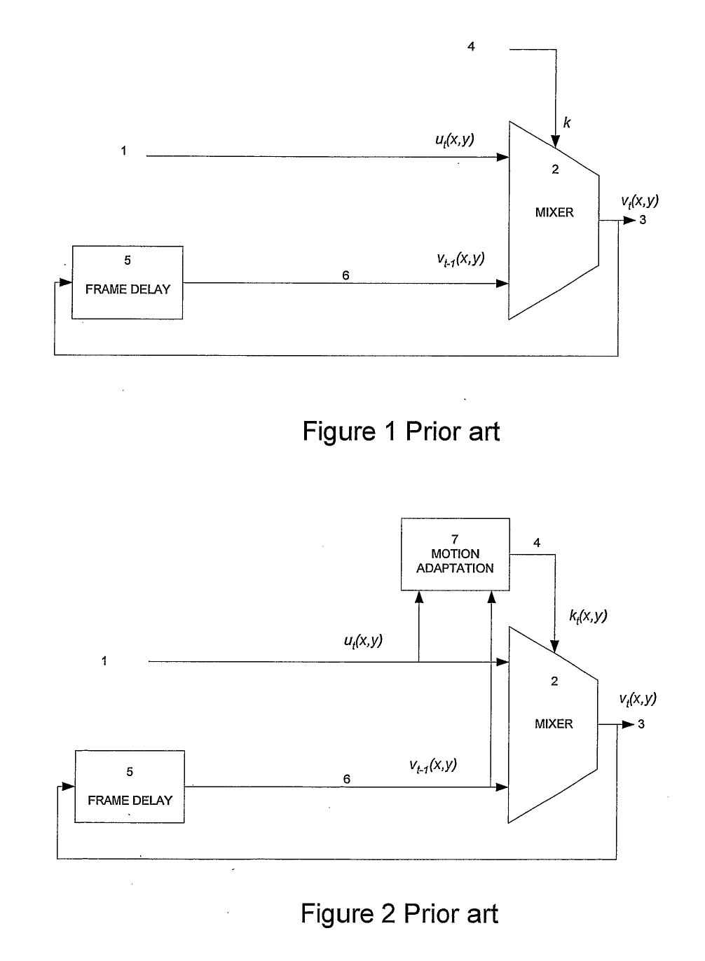

FIG. 1 shows a known simple temporal recursive filter (TRF). An input video signal 1 is applied to a first input of a mixer 2 to give a filtered output video signal 3. The filtered output signal is fed back through a frame delay buffer 5 to give a delayed output video signal 6 which passes to a second input of the mixer 2. The mixer is controlled by a control input 4, with a value k where 0≦k≦1. The frame delay 5 ensures that a co-located pel of the output is mixed with the input pel with a weighting k. If uₜ(x,y) is the input pel of frame t at a position (x,y), and vₜ(x,y) is the output, then:

vₜ(x,y)=kuₜ(x,y)+(1−k)vₜ₋₁(x,y) Equation. 1

For a video sequence consisting of a still scene, i.e. the same on every frame, with noise, which is different on every frame, such a filter will attenuate the noise in accordance with the central limit theorem. Experimentally it has been shown that such a filter also provides useful noise reduction in slowly moving sequences.

However, when the image contains fast motion, the moving object leads to “ghosting” in the image. The delayed frame no longer matches the incoming frame, so pails of the moving object appear as a fading trail behind the object in motion. Useful noise attenuation may still be observed in areas away from the moving object.

### The Motion-Adaptive Temporal Recursive Filter

This problem has led to adoption of a known motion-adaptive temporal recursive filter (MATRF), as shown in FIG. 2.

This filter works in the same way as the TRF of FIG. 1, with same reference numbers denoting identical components. The difference is that the control signal 4 is now adaptively controlled by a motion adaptation block 7, which uses a difference between the delayed output image 6 and the input image 1 to distinguish areas of very poor match, in which it is assumed that the difference is due to motion, from areas which have a good match, in which it is assumed that the difference is due to noise. Areas which have a good match are filtered with a lower value of k.

In principle this filter attempts to identify areas of movement activity within the sequence, by comparing the source and delayed output, and then increases k in these regions. This increases a proportion of the source signal being passed to the output and decreases the feedback, thereby reducing the ghosting artefacts, but also reducing the degree of noise attenuation.

There is a large variety of suitable functions for the motion adaptation block 7. Algorithms with good performance are able to adapt to local, temporal and spatial, statistics so that strong noise attenuation is still possible in areas with low motion even when other parts of the same image contain strong motion. However, the MATRF has a fundamental limitation in that noise cannot be safely removed in areas which are in motion.

This filter is sometimes referred to as a motion-compensated temporal recursive filter. For a more in-depth view of the MATRF see patent applications GB 0610967.2, GB 0610968.0, GB 0610972.2 and GB 0611222.1.

### The Motion-Compensated Temporal Recursive Filter

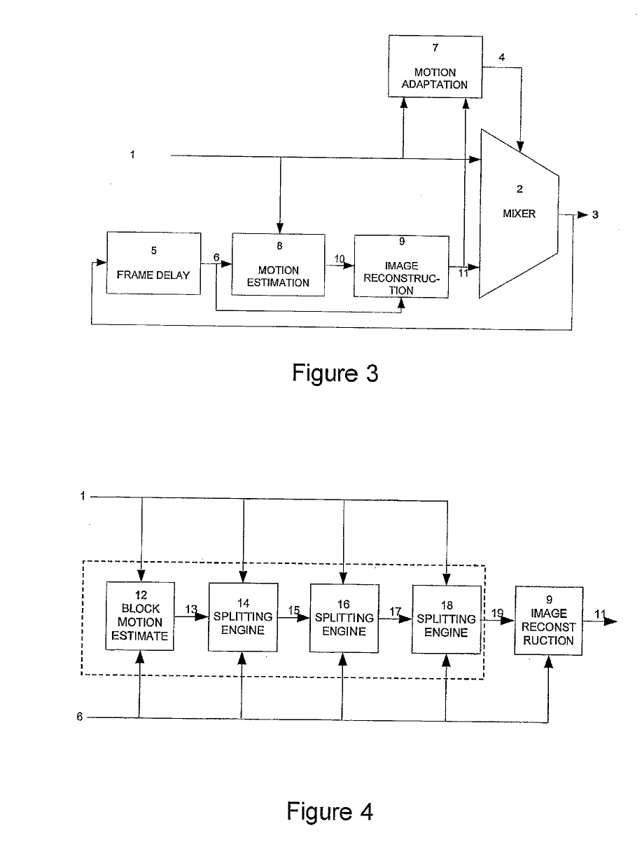

FIG. 3 shows a general structure for a motion-compensated temporal recursive filter (MCTRF). Like the MATRF, the MCTRF includes a motion adaptation function 7 which controls the mixer according to closeness of a match between the predicted image 11 and the source 1.

However, whereas the MATRF of FIG. 2 simply uses the previous output image 6 as the prediction for the current frame, the MCTRF attempts to produce a better estimate by first estimating the motion vectors between an immediately previous output frame and the current input frame, using a motion estimation block 8 outputting vectors 10 and then reconstructing an estimate of the current frame from the previous frame and these vectors using an image reconstruction block 9.

Historically the motion estimation block 8 has employed block-based motion estimation. Where differently moving objects are contained within a same block, this leads to artefacts in the reconstructed image, leading to poor prediction and poor noise attenuation in these areas. The combined processes of motion estimation and reconstruction are referred to as motion compensation herein.

Inter-field processing is in general not used in the MATRF because such processing gives unpleasant effects of vertical judder on static images. The picture delay 5 is therefore usually a frame delay.

It is an object of the present invention at least to ameliorate the aforesaid disadvantages in the prior art.

According to the invention there is provided motion compensation means for a time recursive filter comprises: block motion estimation means having as inputs an input video signal and a delayed output signal of the time recursive filter and arranged to output block motion vectors to at least one block splitting stage arranged to subdivide blocks into partitions and together with the input video signal and the delayed output signal of the time recursive filter to determine vectors for each partition for input into image reconstruction means to produce a motion-compensated image.

Advantageously, the motion compensation means further comprises over-sampling means arranged to produce an over-sampled reference surface for use in at least one refinement engine means arranged to provide a vector with a greater precision than a resolution of the input video in any splitting stages downstream of the refinement engine means and in the image reconstruction means.

According to a second aspect of the invention, there is provided a method of providing motion compensation for a time recursive filter comprising steps of: estimating block motion vectors from an input video signal and a delayed output signal of the time recursive filter; outputting the estimated vectors to the at least one block splitting stage which together with the input video signal and the delayed output signal of the time recursive filter is arranged to produce sub-block motion vectors; and inputting the sub-block motion vectors into image reconstruction means to produce a motion-compensated image.

Advantageously, the method further comprises producing an over-sampled reference surface for use in refinement engine means, in any block splitting stages downstream of the refinement engine means and in the image reconstruction means.

According to a third aspect of the invention, there is provided a computer program product comprising code means for performing all the steps of the method described above when the program is run on one or more computers.

According to a fourth aspect of the invention, there is provided computer program product as described above embodied by a computer storage medium.

The invention will now be described, by way of example, with reference to the accompanying drawings in which:

FIG. 1 is a known temporal recursive filter;

FIG. 2 is a known motion-adaptive temporal recursive filter;

FIG. 3 is a motion-compensated temporal recursive filter suitable for use in the present invention;

FIG. 4 is a motion compensation block in accordance with the invention for use in the motion-compensated temporal recursive filter of FIG. 3; and

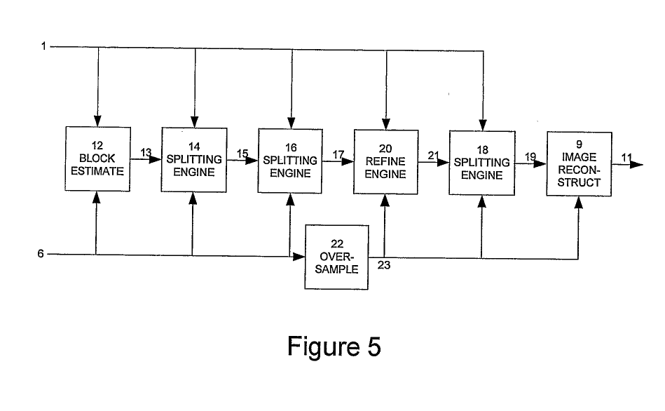

FIG. 5 is a farther embodiment of a motion compensation block in accordance with the invention for use in the motion-compensated temporal recursive filter of FIG. 3.

In the Figures, like reference numbers denote like parts.

FIG. 4 shows a motion compensation block in accordance with the present invention, where corresponding signals and blocks have the same numbers as in previous Figures. The input video signal 1 and delayed output signal 6 are passed to block motion estimation means 12, to output block motion vectors 13. These block motion vectors are input together with the input video signal 1 and delayed output signal 6 to first block splitting means 14, producing sub-block motion vectors 15. Further block splitting means 16, 18 produce motion vectors 17, 19 of smaller sub-sub-block and sub-sub-sub-blocks, respectively. The lowest level of vectors 19 is fed into image reconstruction means 9 to produce the motion-compensated image 11.

A method of splitting a field of block motion vectors into a field of sub-block motion vectors is disclosed in the Applicant's co-pending application filed under reference number P115606GB.

Preferably the lowest level of vectors has a separate vector for every pel in the image.

The ability of the split algorithm to generate useful vectors at the pel level overcomes the deficiency in the prior art that a block situated on a boundary between two objects with different motion is not well predicted if a block is represented with only one motion vector. However, the appearance of the prediction and hence the output image contains other undesirable artefacts:
a) Aliased edges on objects
b) Jerkiness or judder in the motion, particularly vertical judder if the prediction is inter field.

Both of these deficiencies may be overcome by a well-known process of image refinement. This allows motion to be compensated to within an accuracy of typically ½ or ¼ of a pel.

FIG. 5 shows a further embodiment of the invention. At some stage in the chain of splitting engines 14, 16, 18 a refinement engine 20 is introduced, together with an over-sampler 22. The over-sampler produces an over-sampled reference surface 23 which is then used in the refinement engine 20, in any subsequent splitting stages 18 and in the image reconstruction means 9.

One beneficial effect of performing motion refinement to half-pel or better resolution, is that it allows compensation for vertical shift between alternate fields of a picture. This has a beneficial effect because it allows inter-field motion estimation to be performed accurately. Without a half-pel refinement stage, there will always be a half-line mismatch between the reconstructed and input images, which manifests itself as reduced noise suppression and/or a vertical wobble in the output image.

Inter-field prediction keeps the temporal difference between frames, and hence the required range of the motion estimator, as low as possible. The picture delay 5 is also reduced.

It will be understood that the number of stages of splitting and the position of any refinement engine within the splitting stages is a design parameter of the filter. The choice of where to place the refinement engine is influenced by two factors:
1. Attempting to refine blocks which are too small may lead to the refined vectors following random noise rather than an underlying structure of the image.
2. Refining blocks which are too large reduce an ability of the filter to track motion such as stretching and rotating.

A typical system might use an initial block size of 16 by 16 pels, two stages of splitting to give vectors corresponding to 4×4 blocks, refinement of the 4×4 block vectors, and two further stages of splitting to give pel vectors.

A splitting method, as in, for example the Applicant's co-pending application filed under reference no. P115606GB, is applied to the motion estimator within a motion-compensated temporal recursive filter for noise reduction, giving separate vectors for every pel.

Both chrominance and luminance may be considered.

### Key Benefits

The resulting video sequence has better noise reduction and introduces less artefacts than a classical block-based MCTRF. This is an important technology for a pre-processing stage prior to applying a compression algorithm to a video signal.

1-6. (canceled)

7. A motion compensation function for a time recursive filter, comprising:
a block motion estimation function configured to:
receive, as inputs, an input video signal and a delayed output signal of the time recursive filter; and
output block motion vectors;
at least one block splitting stage configured to:
receive the block motion vectors from the block motion estimation function, the input video signal, and the delayed output signal of the time recursive filter;
subdivide blocks into partitions; and
output motion vectors for each partition; and
an image reconstruction function configured to:
receive the determined vectors for each partition from the block splitting stage; and
produce a motion-compensated image.

8. The motion compensation function of claim 7 further comprising:
an over-sampler configured to produce an over-sampled reference surface; and
at least one refinement engine configured to use the over-sampled reference surface to provide a vector having a greater precision than a resolution of the input video in each of one or more splitting stages downstream of the refinement engine, and in the image reconstruction function.

9. A method of providing motion compensation for a time recursive filter, the method comprising the steps of:
estimating block motion vectors from an input video signal and a delayed output signal of a time recursive filter;
outputting the estimated vectors to the at least one block splitting stage, which together with the input video signal and the delayed output signal of the time recursive filter is configured to produce sub-block motion vectors; and
inputting the sub-block motion vectors into an image reconstruction function to produce a motion-compensated image.

10. The method of claim 9 further comprising producing an over-sampled reference surface for use in a refinement engine function, one or more block splitting stages disposed downstream of the refinement engine function, and in an image reconstruction function.

11. A computer program product comprising program code that causes one or more computing devices executing the code to:
estimate block motion vectors from an input video signal and a delayed output signal of a time recursive filter;
output the estimated vectors to the at least one block splitting stage, which together with the input video signal and the delayed output signal of the time recursive filter, is configured to produce sub-block motion vectors; and
input the sub-block motion vectors into an image reconstruction function to produce a motion-compensated image.

12. The computer program product of claim 11 wherein the program code further causes the one or more computers executing the code to produce an over-sampled reference surface for use in a refinement engine function, one or more block splitting stages disposed downstream of the refinement engine function, and in an image reconstruction function.

13. The computer program product of claim 11 wherein the program code is stored in a computer storage medium associated with the one or more computers executing the program code.
